(19) United States
(12) Patent Application Publication
(10) Pub. No.: US 2021/0130037 A1
(43) Pub. Date: May 6, 2021

(54) SMALL LIQUID CONTAINERS

(71) Applicant: Anthony Kobler, Aurora, CO (US)

(72) Inventor: Anthony Kobler, Aurora, CO (US)

(21) Appl. No.: 16/501,135

(22) Filed: Nov. 1, 2019

(51) Int. Cl. B65D 21/02; B65D 17/00; B65D 17/28; C12G 3/00

(52) U.S. Cl. CPC B65D 21/0213; C12G 3/00; B65D 17/4012; B65D 17/02

(57) ABSTRACT

A small volume metal beverage can is provided. The small volume metal beverage can has a diameter approximately equal to a convention, single serving beverage can, which is typically a diameter of between about 2.0 and 2.25 inches, and a length, significantly less than 2.0 inches but sufficient to contain the required volume of liquid for the small volume that comprises a typical single serving size, which single serving size may range from about 0.5 ounces to about 2.5 ounces. The small volume metal beverage can has a base and a top lid connected by a cylindrical sidewall. The base, top lid, and cylindrical sidewall forms a generally squat form taking a shape similar to an ice hockey puck. The top lid is generally formed with a removable opening, such as, for example, a pull tab or pop top. The small volume metal beverage can is stackable on a conventional beverage can.

### CROSS-REFERENCE TO RELATED PATENT APPLICATIONS

None.

### BACKGROUND

The technology of the present application relates to small liquid containers and, more specifically, to small, metal beverage cans that may be provided individually, in combination with standard sized, metal beverage cans, or stacked in packages of similar or mixed beverages.

The conventional beverage can, in the United States, comprises a metal container, typically aluminum, to hold a fixed volume of a beverage. The beverage can typically has a base and a top lid connected by a cylindrical sidewall, which generally forms an elongated cylindrical tube (e.g., longer on its transverse access than it is wide based on its diameter). The top lid has a removable or openable portion on a top, such as a pull tab or a pop top. The capacity of the beverage can in the United States is typically around 12 US fluid ounces or about 355 milliliters.

Over time, many beverage companies introduced both larger and smaller offerings of beverages in metal cans. The metal cans to accommodate the changing volumes generally were narrower or wider but the proportional length to dimeter remained with the length greater than or equal to the diameter of the can. Generally, the volume of the metal beverage can is between about 5 fluid ounces to about 16 fluid ounces in the United States.

However, many single serving beverages are much smaller than even 5 fluid ounces. Also, many smaller sized single serving beverages are combined with a larger single serving beverage. Such as, for example, adding a shot of rum (about 1.5 ounces) to a conventional serving of a cola drink (about 12 ounces). This is problematic for todays conventional servings to combine as the small single servings (e.g., less than 5 fluid ounces) are typically provided in a plastic bottle. Even if provided in a small can, the traditional methods and production results in non-combinable units (as the small can has a diameter much less than the large can).

Thus, against this background, it would be desirable to provide a small, single serving, metal can with a diameter approximately equal to the diameter of a conventional beverage can.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some aspects of the technology, a small volume metal beverage can is provided. The small volume metal beverage can has a diameter approximately equal to a convention, single serving beverage can, which is typically a diameter of between about 2.0 and 2.25 inches, and a length, significantly less than 2.0 inches but sufficient to contain the required volume of liquid for the small volume that comprises a typical single serving size, which single serving size may range from about 0.5 ounces to about 2.5 ounces. The small volume metal beverage can has a base and a top lid connected by a cylindrical sidewall. The base, top lid, and cylindrical sidewall forms a generally squat form taking a shape similar to an ice hockey puck. The top lid is generally formed with a removable opening, such as, for example, a pull tab or pop top.

In some embodiments, the small volume metal beverage can is combinable with a conventional metal beverage can having diameter of between about 2.0 and 2.25 inches and a length sufficient to hold approximately 12 fluid ounces in the United States, which may be between about 4.5 to 5 inches in length. The diameter and formation of the base and top lid of the small volume metal beverage can is sized and shaped to fit within the base and/or top lid of the conventional metal beverage can to form a stackable unit.

In some embodiments, several small volume metal beverage cans are stackable as a unit. The stackable unit of small volume metal beverage cans may comprise all cans of the same length or different lengths, although each of the lengths is less than the diameters of the cans, which are all equal. Moreover, each of the several small volume metal beverage cans in the stackable unit may have the same or different liquids. The same or different liquids may be combinable.

These and other aspects of the present system and method will be apparent after consideration of the Detailed Description and Figures herein.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 is a top perspective view of a small volume liquid container consistent with the technology of the present application.

FIG. 2 is front side view of the small volume liquid container of FIG. 1.

FIG. 3 is a back side view of the small volume liquid container of FIG. 1.

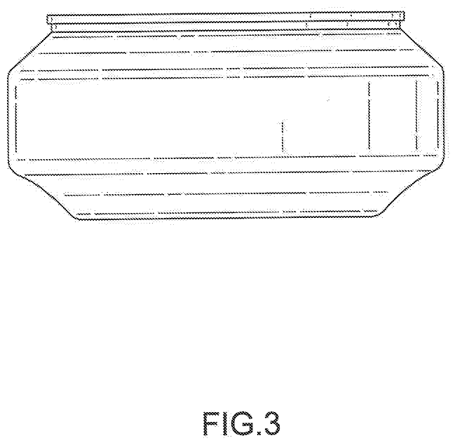

FIG. 4 is a right side view of the small volume liquid container of FIG. 1.

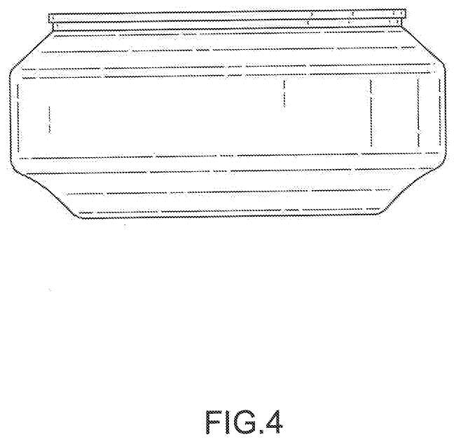

FIG. 5 is a left side view of the small volume liquid container of FIG. 1.

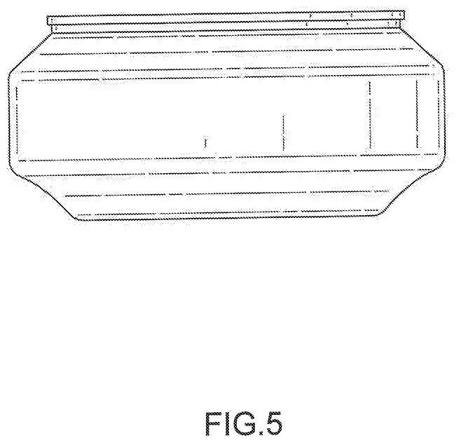

FIG. 6 is a top view of the small volume liquid container of FIG. 1.

FIG. 7 is a bottom view of the small volume liquid container of FIG. 1.

FIG. 8 is a perspective view of the small volume liquid container of FIG. 1 stacked with a conventional volume liquid container consistent with the technology of the present application.

FIG. 9 is a perspective view of stackable unit comprising several small volume liquid containers of FIG. 1 consistent with the technology of the present application

### DETAILED DESCRIPTION

The technology of the present application will now be described more fully below with reference to the accompanying figures, which form a part hereof and show, by way of illustration, specific exemplary embodiments. These embodiments are disclosed in sufficient detail to enable those skilled in the art to practice the technology of the present application. However, embodiments may be implemented in many different forms and should not be construed as being limited to the embodiments set forth herein. The following detailed description is, therefore, not to be taken in a limiting sense.

The technology of the present application is described with specific reference to small volume aluminum beverage cans. However, the technology described herein may be used with applications other than those specifically described herein. Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

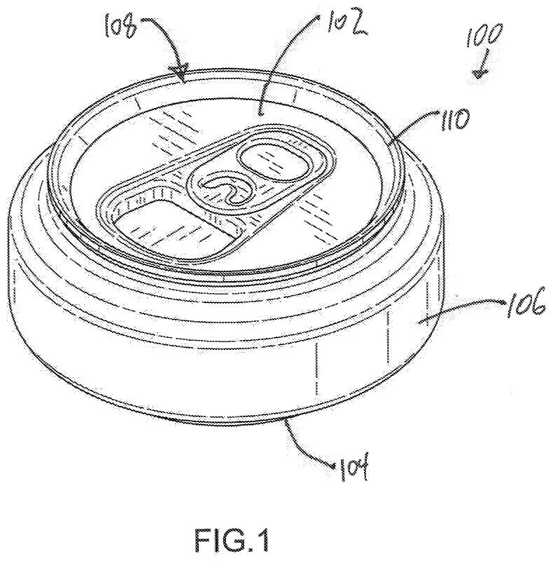

With reference now to FIG. 1, a small volume aluminum beverage can 100 consistent with the technology of the present application is shown. The aluminum beverage can 100 has a top lid 102 and a base 104. A cylindrical sidewall 106 couples the top lid 102 and the base 104. The top lid 102 is formed by a depressed area 108 or cavity surrounded by an annular lip 110.

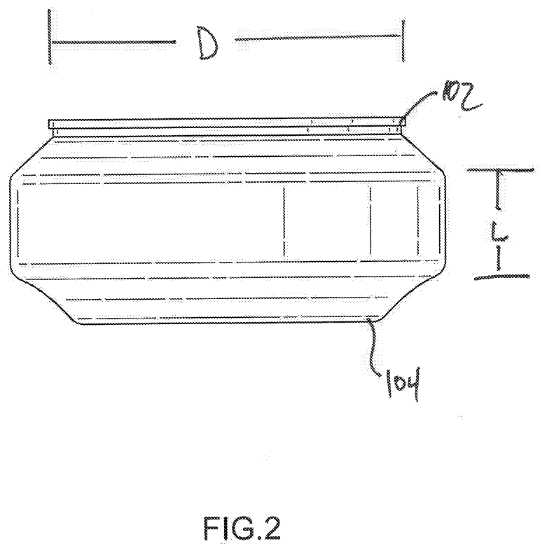

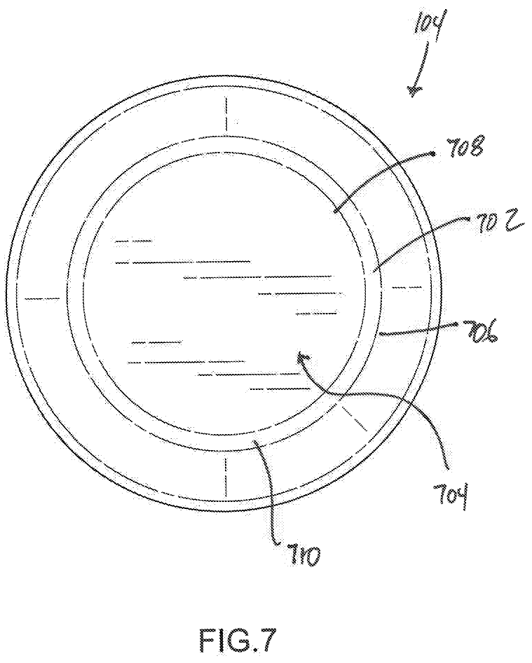

With reference to FIG. 2, the top lid 102 has a diameter D. The cylindrical sidewall has a length L (see FIG. 2). The diameter D is greater than, and in most instances substantially greater than, the length L. With reference to FIG. 7, the base 104 has an annular ridge 702. The annular ridge 702 forms a depressed area 704. The annular ridge 702 is generally formed by an outer wall 706 and an inner wall 708 that converge at a tip 710. The outer wall 706 and the inner wall 708 may be straight or have a arch or radius of curvature. Generally, the annular ridge 702 and the lip 110 are both sized and shaped such that the small volume aluminum beverage can 100 can be stackable, as will be explained further below.

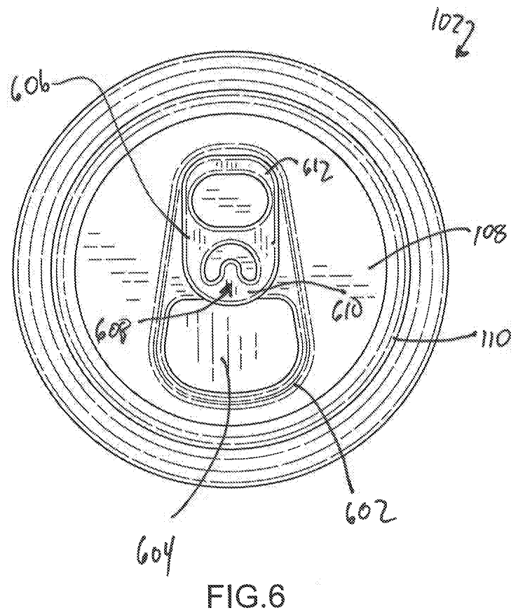

FIG. 6 shows the top lid 102 in more detail. The top lid 102 has the depressed area 108 and the annular lip 110. An etched seam 602 defines a openable tab 604 in the top lid 102. A lever 606 is pivotably coupled to the top lid 102 at a pivot 608 proximal the etched seam 602. The lever 606 has a push end 610 proximal the openable tab 604 and a pull end 612 distal the openable tab 604. To open the small volume aluminum beverage can 100, the pull end 612 of the lever 606 is pulled away from the top lid 102. The lever 606 pivots about the pivot 608 such that pulling the pull end 612 causes the push end 610 to push into the openable tab 604. The openable tab 604 separates along the etched seam 602 and the openable tab 604 moves into the volume defined by the small volume aluminum beverage can 100.

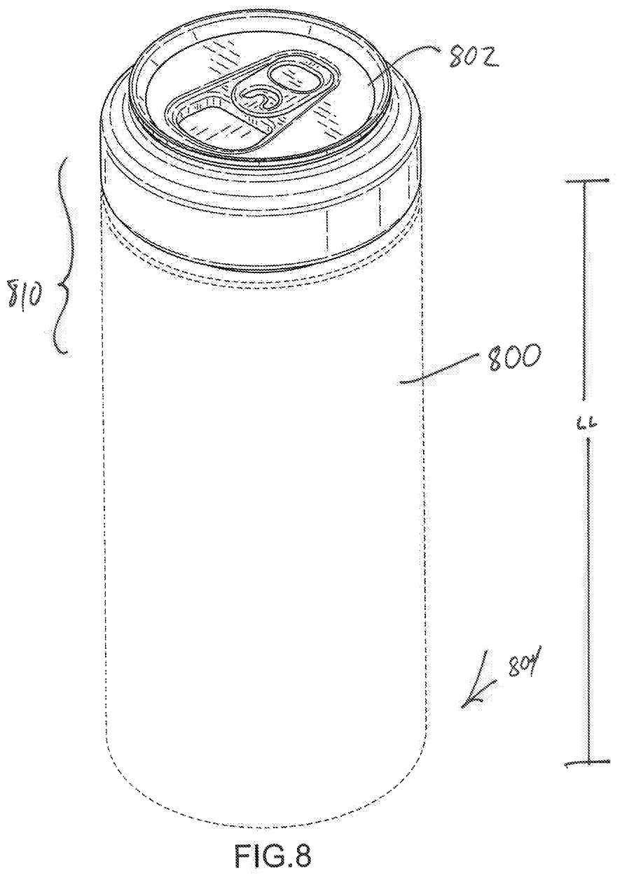

FIG. 8 shows a perspective view of the small volume liquid container 100 stacked with a conventional volume liquid container 800 consistent with the technology of the present application. As can be appreciated, the conventional volume liquid container 800 has a top lid 802 and a base 804 consistent with the top lid 102 and base 104 of the small volume liquid container 100. Thus, the top lid 802 has a diameter D (not specifically shown). As is conventional, the conventional volume liquid container 800 has a length LL greater than, and in most instances much greater than, the diameter D. Also, as the top lid 802 and base 804 are similar to the top lid 102 and base 104, the conventional volume liquid container 800 is stackable with the small volume liquid container 100. As shown, the small volume liquid container 800 is stacked on the top lid 802 of the conventional volume liquid container 800, but in other arrangements, the conventional volume liquid container 800 is stacked on the top lid 102 of the small volume liquid container 100. While only one (1) small volume liquid container 100 is shown stacked with the conventional volume liquid container 800, the combination unit 810 may include multiple small volume liquid containers 800.

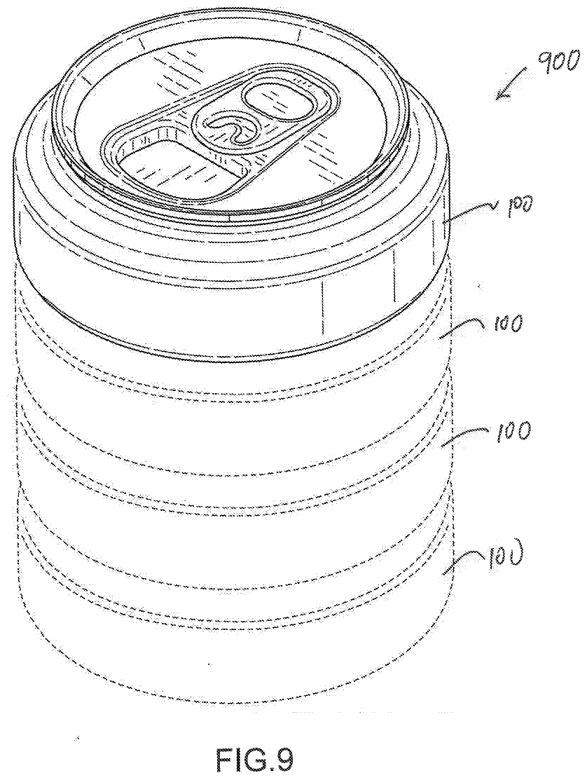

FIG. 9 shows a perspective view of a stackable unit 900 of several small volume liquid containers 100. As shown, the stackable unit 900 comprises four (4) small volume liquid containers 100. While four small volume liquid containers 100 are shown, more or less are possible.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. An apparatus, comprising:
a first metal beverage can, comprising;
a top lid, the top lid having a first depressed area and an annular lip;
a base, the base having a second depressed area and an annular ridge
a cylindrical sidewall connecting the top lid and the base, wherein the top lid has a first diameter and the cylindrical sidewall has a first length such that the first diameter is substantially greater than the first length

2. The apparatus of claim 1, comprising:
a second metal beverage can, comprising;
a second top lid, the second top lid having a third depressed area and a second annular lip;
a second base, the second base having a fourth depressed area and a second annular ridge;
a cylindrical sidewall connecting the second top lid and the second base, wherein the second top lid has a second diameter equal to the first diameter and the second cylindrical sidewall has a second length greater than the second diameter and wherein the first metal beverage can is stackable on the second metal beverage can.

3. The apparatus of claim 1, wherein the apparatus comprises a plurality of first metal beverage cans wherein the plurality of first metal beverage cans form a stack.

4. The apparatus of claim 3, wherein the plurality of first metal beverage cans comprises at least four (4) first metal beverage cans forming the stack.

5. The apparatus of claim 4, wherein the plurality of first metal beverage cans comprises at least 8 (8) first metal beverage cans forming at least two stacks.

6. The apparatus of claim 1, wherein the first depressed area comprises an etched seam.

7. The apparatus of claim 6, wherein the etched seam forms an openable tab.

8. The apparatus of claim 1, wherein the annular ridge is formed by an outer wall and an inner wall.

9. The apparatus of claim 8, wherein at least one of the outer wall and the inner wall have a radius of curvature.

10. The apparatus of claim 2, wherein the apparatus comprises at least two first metal beverage cans stackable with the second metal beverage can.

11. The apparatus of claim 2, wherein the first metal beverage can comprises a first liquid and the second metal beverage can comprises a second liquid.

12. The apparatus of claim 11, wherein the first liquid is a spirit and the second liquid is not a spirit.

13. The apparatus of claim 1, wherein the first diameter is between about 2 and 2.25 inches.

14. The apparatus of claim 13, wherein the first metal beverage can has a volume between 0.5 and 2.5 ounces.

15. The apparatus of claim 14, wherein the first metal beverage can has a first length less than 2 inches.
